(19) United States
(12) Patent Application Publication
(10) Pub. No.: US 2004/0239605 A1
(43) Pub. Date: Dec. 2, 2004

(54) Device and method for driving polarity inversion of electrodes of LCD panel

(75) Inventors: Ching-Tung Wang, Jubei City (TW); Fu-Zhi Chang, Changhua City (TW)

Correspondence Address: VOLPE AND KOENIG, P.C., UNITED PLAZA, SUITE 1600, 30 SOUTH 17TH STREET, PHILADELPHIA, PA, 19103, US

(73) Assignee: Toppoly Optoelectronics Corp., Chu-Nan (TW)

(21) Appl. No.: 10/849,753

(22) Filed: May 20, 2004

(30) Foreign Application Priority Data
May 26, 2003 (TW) 092114187

(51) Int. Cl. G09G 3/36

(52) U.S. Cl. 345/96

(57) ABSTRACT

A device for driving polarity inversion of electrodes of a liquid crystal display (LCD) panel includes a time sequence controller and a source driver. In order to drive polarity inversion of electrodes of the LCD panel, a polarity inverting signal is provided and a digital video data is outputted, wherein the polarity inverting signal has a frequency higher than a scan frequency of scan lines but lower than a display frequency of sub-pixels. Then, the digital video data is converted into an analog video data. The analog video data has a polarity inverting frequency substantially equal to the frequency of the polarity inverting signal.

### FIELD OF THE INVENTION

The present invention relates to a device and a method for driving the polarity inversion of electrodes, and more particularly to a device and a method for driving the polarity inversion of electrodes of a liquid crystal display (LCD) panel.

### BACKGROUND OF THE INVENTION

When producing a thin film transistor liquid crystal display (TFTLCD), liquid crystal molecules are infused into the space between an upper glass substrate and a lower glass substrate. The plurality of TFT units formed on the lower glass substrate controls the rotation and alignment of the liquid crystal molecules thereabove by providing various voltages to result in various electric fields. Due to the difference in rotating angles of the liquid crystal molecules controlled by respective TFT units, the backlight, when penetrating through the liquid crystal layer, is differentially deviated so as to exhibit a specific level of gray-scale brightness at a corresponding monochromatic color filter disposed on the upper glass substrate for each sub-pixel. The sub-pixel is one of the three primary colors, i.e. red, green and blue, and three sub-pixels respectively representing red, green and blue are combined as a pixel. In response to the independent variations of the three sub-pixels controlled by respective TFT units, various colors can be obtained for that pixel. Accordingly, a full-color effect can be rendered.

Due to the feature of liquid crystal, the display voltage applied to two ends of the display electrode, which is electrically connected to the TFT unit, should not be kept unchanged for a long time. Otherwise, the property of the liquid crystal molecules will be changed after the applied voltage is removed. As a result, the liquid crystal molecules will be unable to rotate with various electric fields to exhibit various gray-scale levels. In order to solve this problem, the polarities of two ends of the display electrode are exchanged alternately. When the voltage applied to the display electrode is higher than the voltage applied to the common electrode, which is also referred to as ground electrode, it is of positive polarity. On the contrary, when the voltage applied to the display electrode is lower than the voltage applied to the common electrode, it is of negative polarity. No matter it is of positive or negative polarity, i.e. no matter which of the voltages applied to the display electrode and the common electrode is higher than the other, the same gray-scale level will be exhibited as long as the potential differences between the two electrodes have the same absolute value. Nevertheless, the rotation-angle distributions of the liquid crystal molecules in these two polarities are contrary to each other. Therefore, each of the liquid crystal molecules will not be kept at the same orientation all the time. By alternating the polarities of the electrodes at intervals, the liquid crystal molecules can be protected from property deterioration without influencing the display of the desired frame.

Now referring to FIG. 1, the driving means of the LCD panel is illustrated. As shown, a driving device 10 includes at least a time sequence controller 11 and a source driver 12. The time sequence controller 11 provides a polarity inverting signal S11 and a digital video data S12 to the source driver 12. The source driver 12 generates an analog video data S13, i.e. the aforementioned display voltage, according to the level change of the polarity inverting signal S11. The analog video data S13 includes a pair of data with potential differences having the same absolute value but contrary polarities, and is outputted to the two ends of the display electrode of the LCD panel 20. Whether the potential level of the display electrode should be higher or lower than that of the common electrode is determined by the polarity inverting signal S11.

The means for changing polarities of the analog video data S13 in response to the polarity inverting signal S11 generated by the time sequence controller 11 is diverse in the prior art. Examples are given as shown in FIGS. 2A˜2D. In the example of FIG. 2A, frame inversion is performed. In a preceding frame, all the sub-pixels A in the entire frame of the LCD panel 20 have the same polarity, e.g. “+”. After frame inversion, all the sub-pixels A′ in the entire frame of the LCD panel 20 have the same polarity complementary to the polarity of the sub-pixels A, i.e. “−”. In the example of FIG. 2B, row inversion is performed. In other words, the sub-pixels B in the same row of the frame have the same polarity but the sub-pixels B in the adjacent rows have complementary polarities. After the row inversion, the sub-pixels B′ in the same row of the frame still have the same polarity and the sub-pixels B′ in the adjacent rows still have complementary polarities. Each of the sub-pixel B and the corresponding inverted sub-pixel B′, however, have complementary polarity. In the example of FIG. 2C, column inversion is performed. In other words, the sub-pixels C in the same column of the frame have the same polarity but the sub-pixels C in the adjacent columns have complementary polarities. After the row inversion, the sub-pixels C′ in the same column of the frame still have the same polarity and the sub-pixels C′ in the adjacent columns still have complementary polarities. Each of the sub-pixels C and the corresponding inverted sub-pixels C′, however, have complementary polarity. In the example of FIG. 2D, dot inversion is performed. Before the dot inversion, the polarity of each of the sub-pixels D is different from its immediately adjacent upper, lower, left-side and right-side sub-pixels. After the dot inversion, the polarity of each of the sub-pixels D′ is changed to a complementary polarity, but is still different from its immediately adjacent sub-pixels.

In general, the dot inversion is the most popular in consideration of flickering and crosstalking effects. Unfortunately, it is also disadvantageous in some aspect. As is known, the polarity change is performed upon refreshing next frame. For example, if the refreshing frequency of a frame is 60 Hz, it means the frame is refreshed every 16.67 ms. Therefore, each of the sub-pixel changes polarities very frequently. Particularly for the dot inversion, the level change in response to the polarity inverting signal S11 is performed for every signal sub-pixel, the polarity switching of the analog video data S13 will be also very frequent. As a result, it is unsatisfactory in power consumption and design.

### SUMMARY OF THE INVENTION

Therefore, an object of the present invention is to provide a device and a method for driving the polarity inversion of electrodes in a dot inversion manner with reduced polarity switching frequency.

A first aspect of the present invention relates to a method for driving polarity inversion of electrodes of a liquid crystal display (LCD) panel. The method comprises steps of: providing a polarity inverting signal and a digital video data, the polarity inverting signal having a frequency higher than a scan frequency of scan lines but lower than a display frequency of sub-pixels; and converting the digital video data into an analog video data, the analog video data having a polarity inverting frequency substantially equal to the frequency of the polarity inverting signal.

A second aspect of the present invention relates to a device for driving polarity inversion of electrodes of a liquid crystal display (LCD) panel. The device comprises a time sequence controller providing a polarity inverting signal and a digital video data, the polarity inverting signal having a frequency higher than a scan frequency of scan lines but lower than a display frequency of sub-pixels; and a source driver electrically connected to the time sequence controller and the liquid crystal display (LCD) panel for converting the digital video data into an analog video data according to the polarity inverting signal and the digital video data, the analog video data having a polarity inverting frequency substantially equal to the frequency of the polarity inverting signal.

Preferably, the frequency of the polarity inverting signal is substantially equal to a display frequency of pixels, wherein each pixel consists of three adjacent sub-pixels, e.g. red, green and blue sub-pixels.

Preferably, the analog video data optionally includes a first or a second data, and the first and the second data have the same absolute value of potential differences, but have contrary polarities.

In one embodiment, the analog video data are outputted to two ends of a display electrode of the LCD panel.

For example, a frame-refreshing frequency of the LCD panel is 60 Hz.

### BRIEF DESCRIPTION OF THE DRAWINGS

The present invention may best be understood through the following description with reference to the accompanying drawings, in which:

FIG. 1 is a functional block diagram illustrating a polarity inverting device according to a prior art;

FIG. 2A is a table schematically showing a conventionally used polarity inverting method in a frame inversion manner;

FIG. 2B is a table schematically showing a conventionally used polarity inverting method in a row inversion manner;

FIG. 2C is a table schematically showing a conventionally used polarity inverting method in a column inversion manner;

FIG. 2D is a table schematically showing a conventionally used polarity inverting method in a dot inversion manner;

FIG. 3 is a flowchart schematically showing a polarity inverting method according to the present invention;

FIG. 4 is a functional block diagram illustrating a polarity inverting device according to the present invention;

FIG. 5 is a table schematically showing a preferred embodiment of a polarity inverting method according to the present invention; and

FIG. 6 is a schematic diagram showing the layout of an LCD panel, in which each TFT controls a sub-pixel R, G or B of a pixel.

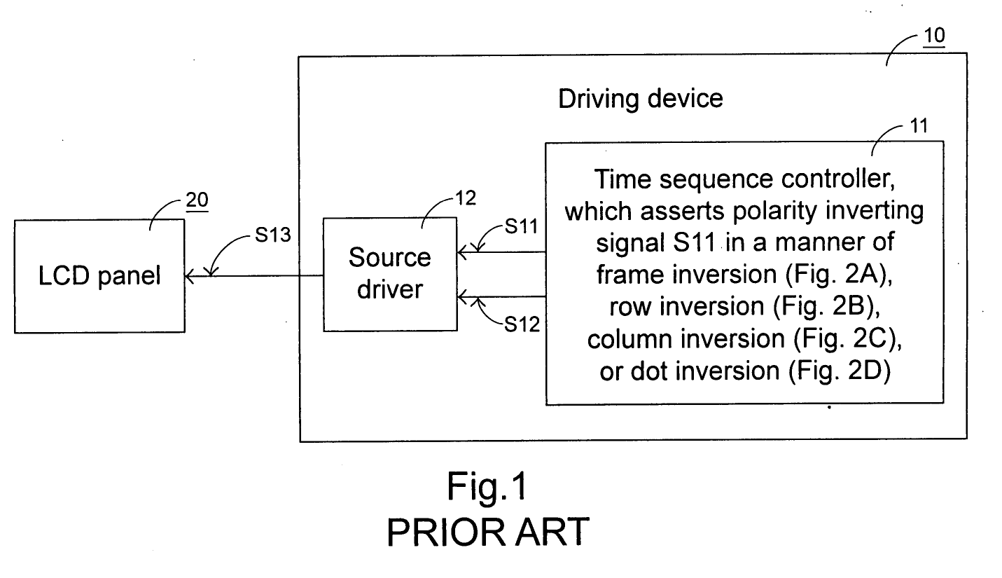

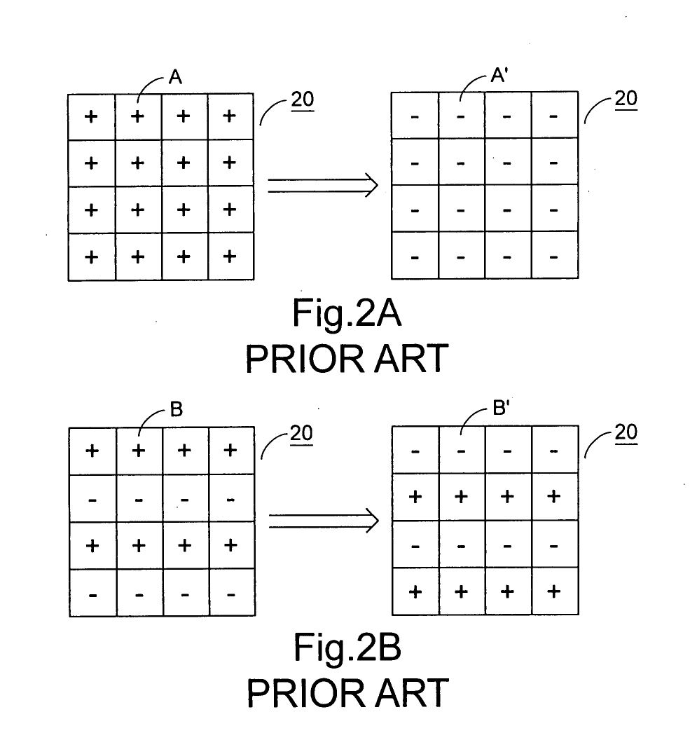

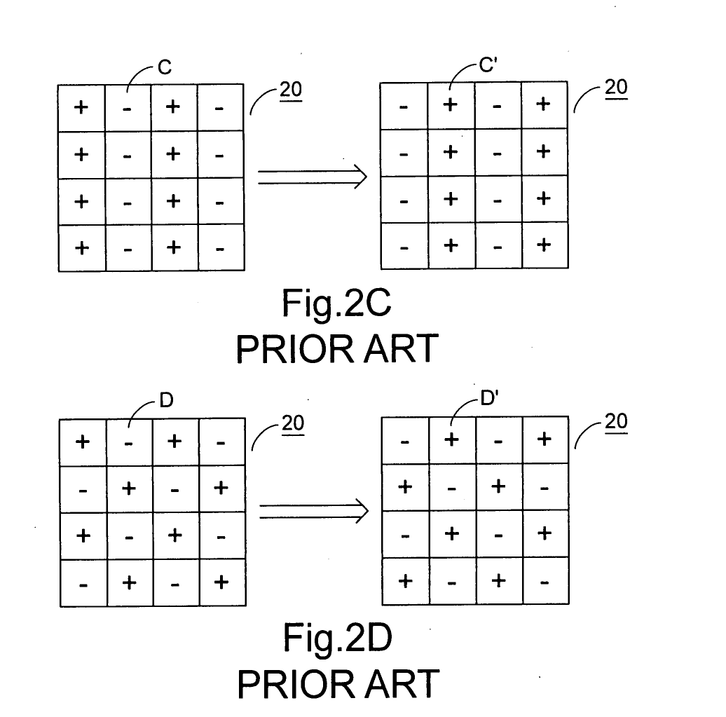

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

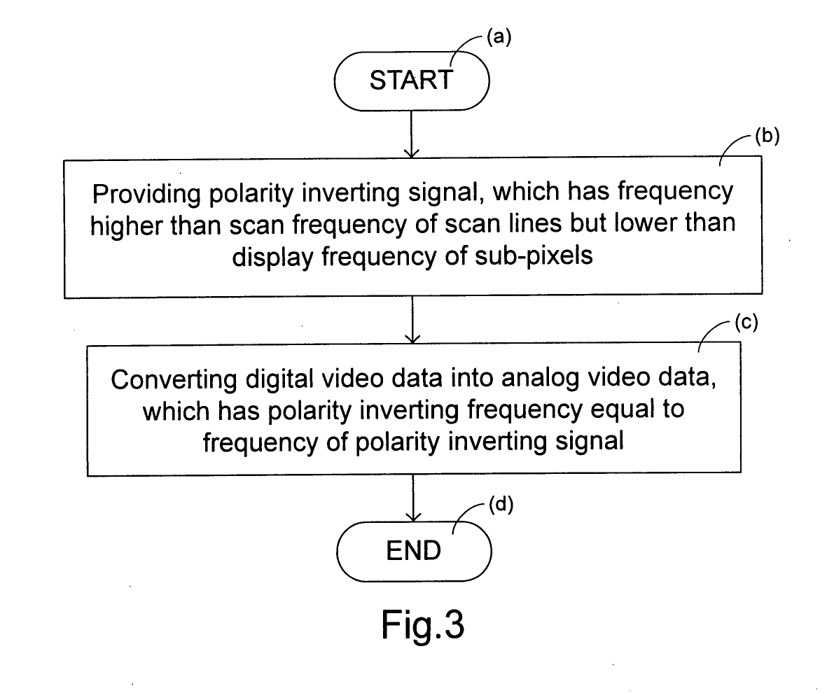

In consideration of image quality, dot inversion means is preferably applied hereto for minimizing flicker and crosstalk effects. In order to solve the frequently switching polarity problem encountered in the prior art, the polarity switching frequency is properly reduced according to the present method as illustrated in a flowchart of the present polarity inverting method and as shown in FIG. 3.

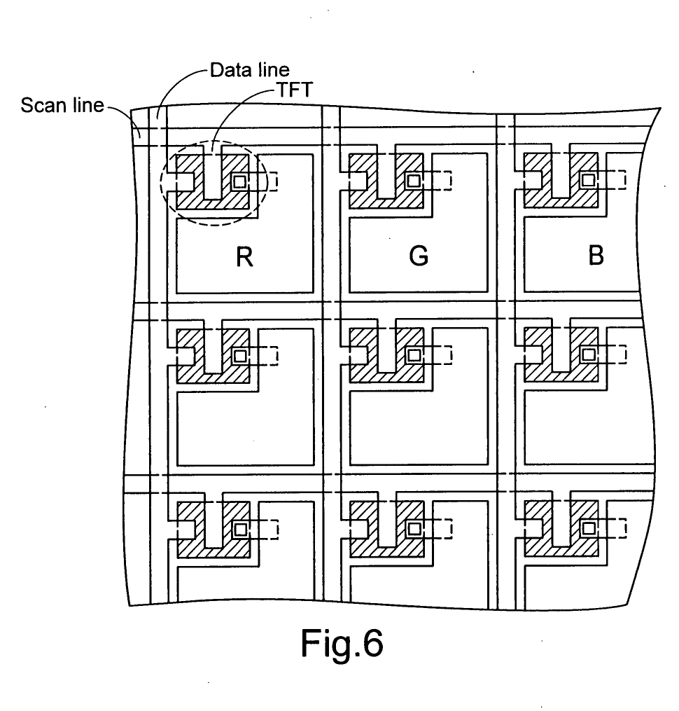

In Step (b) of FIG. 3, a polarity inverting signal and a digital video data are provided, wherein the polarity inverting signal has a frequency higher than a scan frequency of scan lines but lower than a display frequency of sub-pixels. In general, three adjacent sub-pixels, e.g. red (R), green (G) and blue (B) sub-pixels as shown in FIG. 6, consists a pixel. Under this circumstance, the frequency of the polarity inverting signal is substantially equal to the display frequency of pixels.

In Step (c) of FIG. 3, the digital video data is converted into an analog video data according to the polarity inverting signal and the digital video data. The analog video data has a polarity inverting frequency substantially equal to the frequency of the polarity inverting signal. Preferably, the analog video data can be one of a first and a second data having the same absolute value of potential differences but contrary polarities in response to the polarity inverting signal. The analog video data is outputted to two ends of a display electrode of the LCD panel. For example, a frame-refreshing frequency of the LCD panel is 60 Hz.

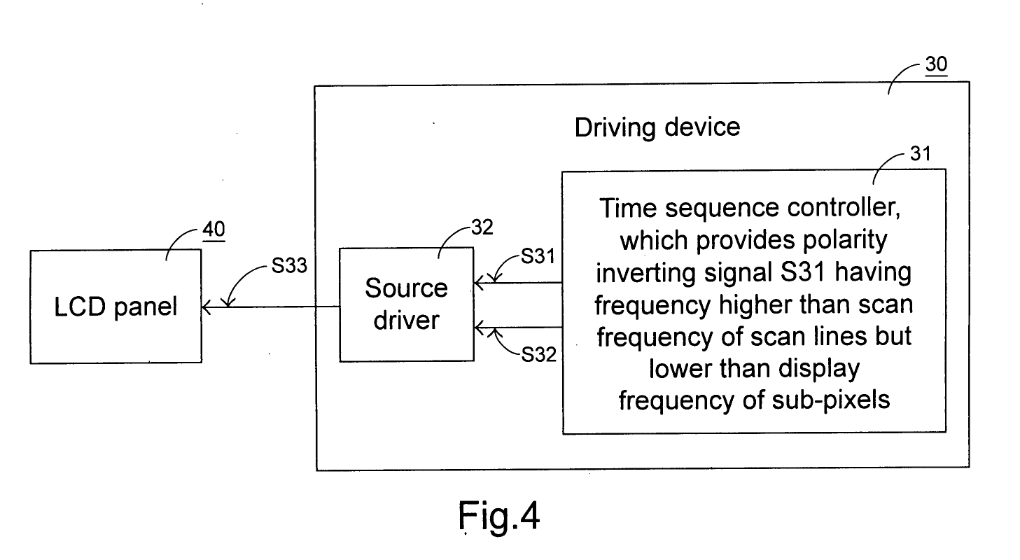

The above method can be implemented by a device shown in FIG. 4. As shown, a driving device 30 includes at least a time sequence controller 31 and a source driver 32. The time sequence controller 31 provides a polarity inverting signal S31 and a digital video data S32 to the source driver 32. The source driver 32 generates an analog video data S33 according to the digital video data S32 and the level change of the polarity inverting signal S31. The analog video data S33 includes a pair of data with potential differences having the same absolute value but contrary polarities, and is outputted to the two ends of the display electrode of the LCD panel 30.

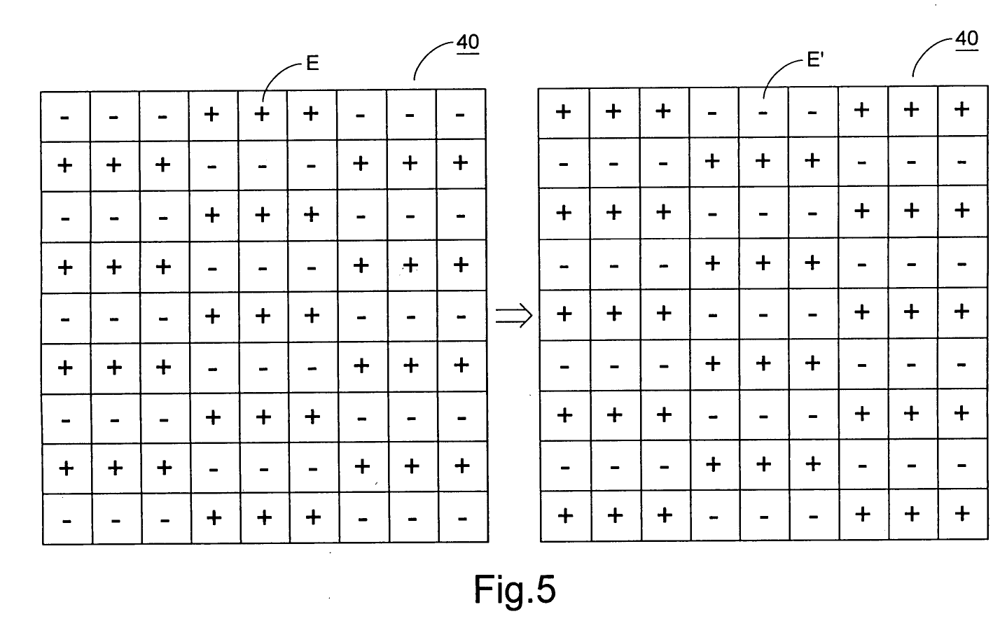

In the time sequence controller, the polarity inverting signal S31 having a specially designed frequency is generated. The frequency of the polarity inverting signal S31 is higher than a scan frequency of scan lines but lower than a display frequency of sub-pixels. By giving the dot inversion manner as an example and referring to FIG. 5, the present inversion method is illustrated. As shown, each pixel consisting of three adjacent sub-pixels E, e.g. red (R), green (G) and blue (B) sub-pixels as shown in FIG. 6, has different polarity from any of its immediately adjacent pixels. On the other hand, the three adjacent sub-pixels E belonging to the same pixel have the same polarity. In other words, the dot inversion according to the present invention is performed pixel by pixel instead of sub-pixel by sub-pixel so as to reduce the polarity switching frequency. As understood, due to the reduction of the polarity switching frequency, the power consumption of the source driver for polarity switching operations can also be reduced. After the dot inversion, each pixel consisting of three sub-pixels E′ still has different polarity from any of its immediately adjacent pixels. Each group of three sub-pixels E and the corresponding inverted sub-pixels E′, however, have complementary polarity.

According to the present invention, the power consumption of the analog video data S33 applied to two ends of the display electrode of the LCD panel can be effectively reduced due to the reduction of the polarity switching frequency. It is understood that the polarity switching operation according to the present invention is based on pixels, which is similar to the dot inversion manner. Therefore, the display quality can be retained.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for driving a liquid crystal display (LCD) device, comprising steps of:
providing a polarity inverting signal and a digital video data, said polarity inverting signal having a frequency higher than a scan frequency of scan lines but lower than a display frequency of sub-pixels; and
converting said digital video data into an analog video data, said analog video data having a polarity inverting frequency substantially equal to said frequency of said polarity inverting signal.

2. The method according to claim 1 wherein said frequency of said polarity inverting signal is substantially equal to a switching frequency of pixels, wherein each pixel consists of three adjacent sub-pixels.

3. The method according to claim 2 wherein said three adjacent sub-pixels consisted in each pixel are red, green and blue sub-pixels.

4. The method according to claim 1 wherein said analog video data optionally includes a first or a second data, and said first and said second data have the same absolute value of potential differences, but have contrary polarities.

5. The method according to claim 1 wherein said analog video data are outputted to two ends of a display electrode of said LCD panel.

6. A device for driving a liquid crystal display (LCD) device, comprising:
a liquid crystal display panel;
a time sequence controller providing a polarity inverting signal and outputting a digital video data, said polarity inverting signal having a frequency higher than a scan frequency of scan lines but lower than a display frequency of sub-pixels; and
a source driver electrically connected to said time sequence controller and said liquid crystal display (LCD) panel for converting said digital video data into an analog video data according to said polarity inverting signal and said digital video data, said analog video data having a polarity inverting frequency substantially equal to said frequency of said polarity inverting signal.

7. The device according to claim 6 wherein said frequency of said polarity inverting signal is substantially equal to a switching frequency of pixels, wherein each pixel consists of three adjacent sub-pixels.

8. The device according to claim 7 wherein said three adjacent sub-pixels consisted in each pixel are red, green and blue sub-pixels.

9. The device according to claim 6 wherein said analog video data optionally includes a first or a second data, and said first and said second data have the same absolute value of potential differences, but have contrary polarities.

10. The device according to claim 6 wherein said analog video data are outputted to two ends of a display electrode of said LCD panel.
